(19) United States
(12) Patent Application Publication
(10) Pub. No.: US 2003/0085578 A1
(43) Pub. Date: May 8, 2003

(54) Door latch and door latch installation method

(76) Inventor: Adrian V. Bromhall, Wolverhampton (GB)

Correspondence Address: CARLSON, GASKEY & OLDS, P.C., 400 WEST MAPLE ROAD, SUITE 350, BIRMINGHAM, MI, 48009, US

(21) Appl. No.: 10/281,441

(22) Filed: Oct. 25, 2002

(30) Foreign Application Priority Data
Nov. 8, 2001 (GB) GB 0126790.5

(51) Int. Cl. E05C 3/06

(52) U.S. Cl. 292/216

(57) ABSTRACT

A door latch for a vehicle door comprising a first lever for the transmission of a first input to the latch from first input means and a second lever for the transmission of a second input to the latch from second input means, wherein the first lever is capable of retaining the second lever in a retracted position when the first lever is in a rest position, but when the first lever is in an actuated position, enables the second lever to move to a deployed position at which the second lever may transmit the second input from the second input means.

The present invention relates to a door latch and to a method of installing a door latch. More particularly, the present invention relates to a door latch for a vehicle door and a method of installing a door latch in a vehicle door.

It is becoming increasingly prevalent to fit a number of door components such as latches, window regulators, and speakers to a door subassembly commonly known as a door module. This enables the subassembly to be assembled away from the vehicle assembly line, and can therefore minimise the overall assembly time of a vehicle by enabling the module to be fitted to the door as a single item on the assembly line.

Doors are generally assembled from the outside face in. This means that the door outside release handle and key barrel must normally be fitted to the outer door skin prior to the fitting of the door module. Additionally, once the door module is fitted, it is difficult to access the void between the door module and the door outer skin to manually connect the inside release handle and key barrel to their respective linkages that transmit inputs therefrom to the latch. Furthermore, it is undesirable to attempt to connect these linkages whilst installing the door module since the process can be fiddly and the overall assembly time is therefore increased. The linkages may also foul on other door fittings during fitment of the door module if left unrestrained.

The present invention seeks to overcome, or at least mitigate, the aforesaid problems.

One aspect of the present invention provides a door latch for a vehicle door comprising a first lever for the transmission of a first input to the latch from first input means and a second lever for the transmission of a second input to the latch from second input means, wherein the first lever is capable of retaining the second lever in a retracted position when the first lever is in a rest position, but when the first lever is in an actuated position, enables the second lever to move to a deployed position at which the second lever may transmit the second input from the second input means.

Embodiments of the present invention will now be described, by way of example only, with reference to the accompanying drawings in which:

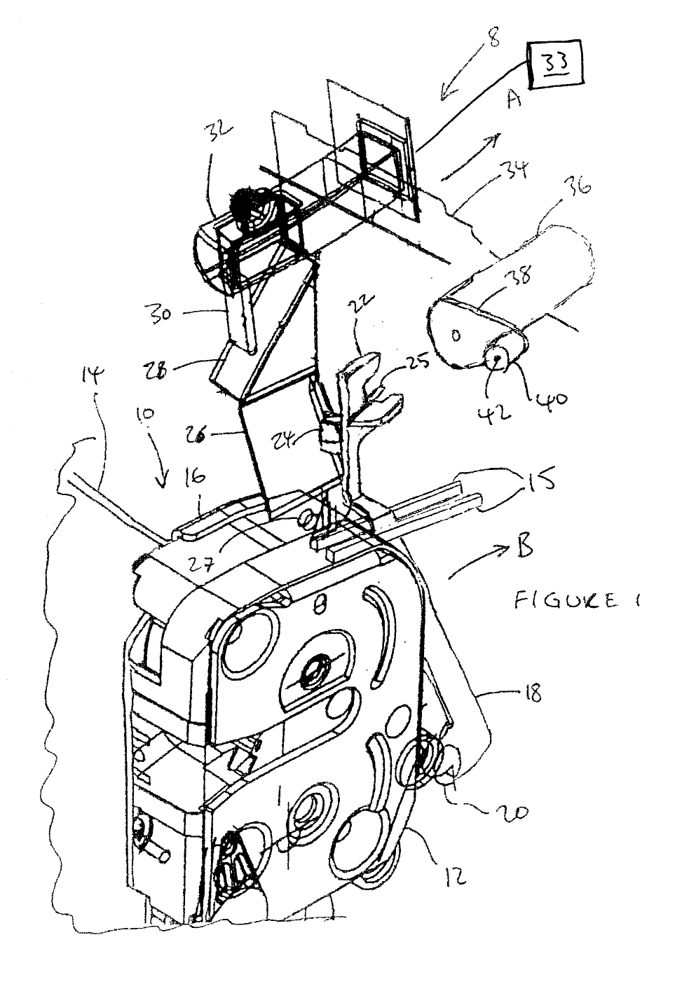

FIG. 1 is a perspective view of a portion of a door including a latch according to the present invention, showing a lever of the latch in a first position;

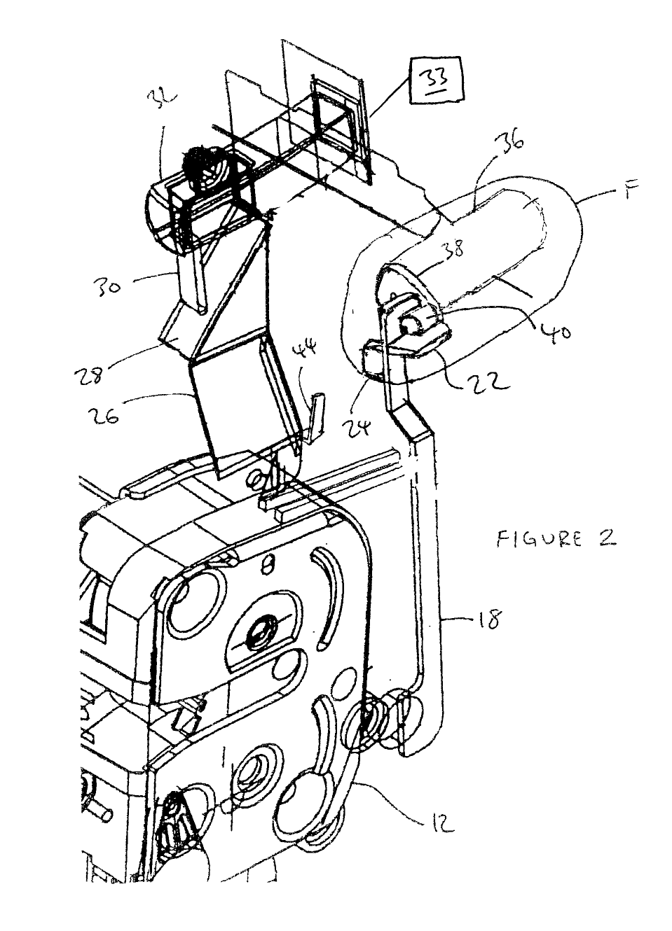

FIG. 2 is a perspective view of the latch of FIG. 1 showing the lever in a second position;

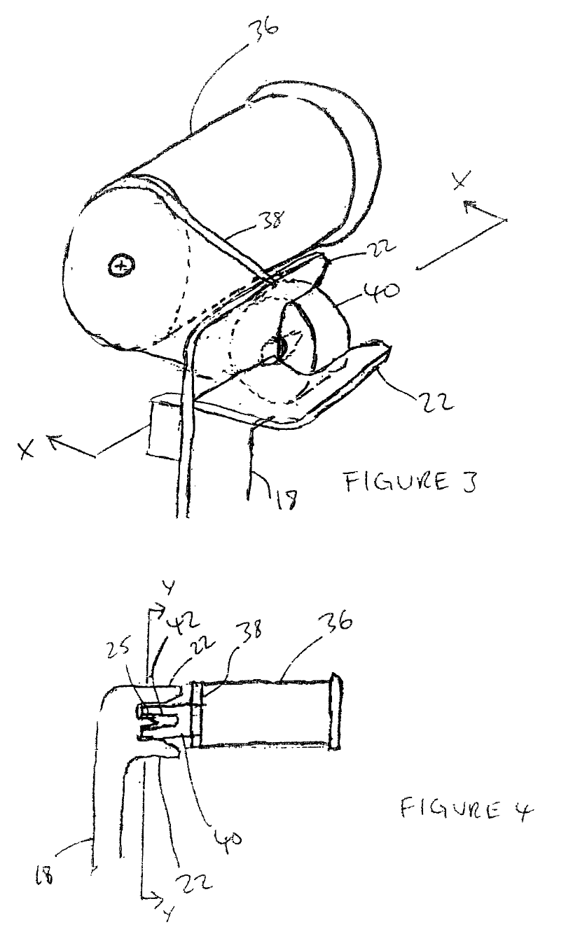

FIG. 3 is an enlarged perspective view of the portion F circled in FIG. 2;

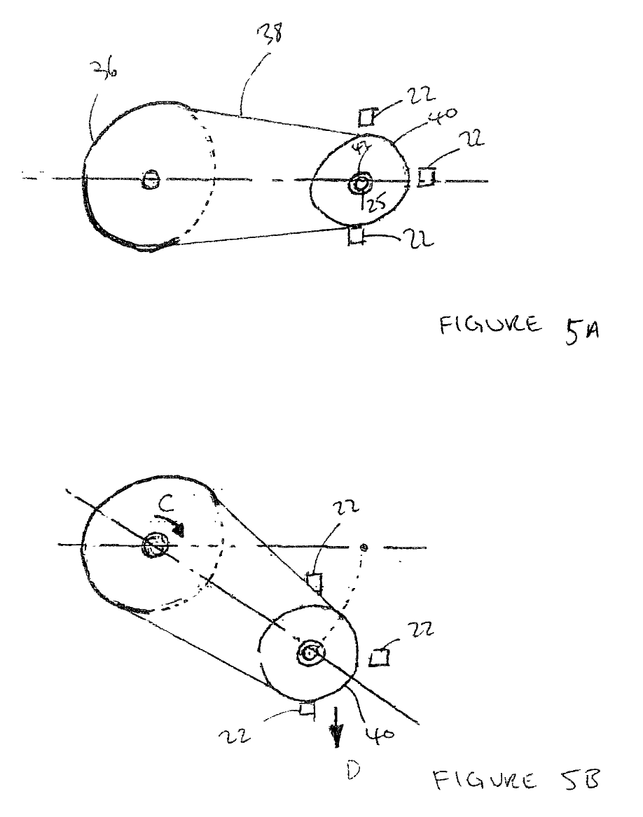

FIG. 4 is a cross section along the axis X-X of FIG. 3; and

FIGS. 5A and 5B are cross-sectional views of the key barrel of FIG. 4 in first and second positions viewed along the axis Y-Y of FIG. 4.

Referring to FIG. 1, there is shown a portion of a door 8 in which, for clarity, the majority of the door skin is not shown. A door module 10 is secured to the door by fasteners such as screws (not shown), for example. The module 10 comprises in this embodiment, a latch 12 and an intermediate panel 14 to which the latch is secured by a bracket 16.

The latch 12 is provided with a key lever 18, which when installed in the door is arranged to transmit inputs from key barrel 36 via barrel output arm 38 and coupling 40 as described in greater detail below. A guide means in the form of a pair of parallel spaced guide bars 15, between which the key lever 18 is arranged, is preferably provided on the latch 12 to ensure that the key lever deploys along the correct path as described below. The latch further comprises an outside handle release lever or paddle 26 pivotally mounted at pivot 27 to the latch and provided with an inclined ramp surface 28 arranged to be engaged by a finger 30 of an outside release handle linkage 32 from an outside release handle illustrated schematically at 33.

Considering the key lever in more detail, it can be seen that in FIG. 1 the lever 18 is restrained in a retracted position due to lug 24 (of lever 18) engaging with a projection 44 provided on outside release lever 26. The projection 44 is obscured in FIG. 1 but is visible in FIG. 2. Key lever 18 is rotatably mounted to the latch about pivot 20 and is resiliently biased in a clockwise direction (B) by suitable means such as a torsion spring (not shown). However, the movement of key lever 18 to lock and unlock the latch is substantially vertical.

In order to engage the key barrel, a suitable formation is provided at the free end of the key lever 18. This can be seen most clearly in FIGS. 3 and 4, and this embodiment comprises three guide teeth 22 having appropriate mutual spacing to receive the coupling 40. To accommodate any tolerance errors in the positioning of the arm 18 relative to the key barrel 36, the ends of each tooth 22 are preferably bevelled to guide the arm 18 into engagement with the coupling 40. To provide positive engagement between the arm 18 and the coupling 40, a projection 25 is preferably provided on the arm 18 to engage in a central aperture 42 provided in the connector 40.

During assembly (with the outside release handle linkage 32 and the key barrel 36, output arm 38 and coupling 40 in place), a door assembler offers the door module 10 up to the door 8 and secures the two assemblies together using suitable fasteners such as screws. During this installation, the key lever 18 is held in the restrained position shown in FIG. 1 behind projection 44. In this position, the risk of lever 18 fouling on one of the door components is reduced. The installation process also causes the ramp surface 28 of release lever 26 to be positioned outside of finger 30.

To release the arm 18, the door assembler pulls on the door outside release handle (not shown) that has previously been installed on the door outer skin 34 in a direction indicated by arrow A. This in turn causes finger 30 of linkage 32 to ride along ramp surface 28 and cause release lever 26 to pivot in a clockwise direction as shown in FIG. 1. This pivoting motion causes lug 24 on the lever 18 to clear projection 44 on the release lever 26 (since pivot 27 is higher up the latch than pivot 20) enabling the lever 18 to pivot in the direction B under the influence of the resilient biasing means, and to be guided into engagement with coupling 40 by guides 15. The engaged position of the key lever 18 is shown in FIG. 2. The lever is maintained in this engaged position by virtue of the resilient biasing means.

Referring now to FIGS. 5A and 5B, the operation of the key barrel arm 38 is shown. FIG. 5A illustrates the rest position of the key barrel 36. When a vehicle user inserts an appropriate key (not shown) into key barrel 36 and turns the key in a clockwise direction as illustrated by arrow C in FIG. 5B, this in turn causes key barrel arm 38 to rotate clockwise by a corresponding amount and thereby causes the upper end of lever 18 to trace an arcuate path having a primarily vertical component to its movement. Lever 18 is provided with some flexibility to its left and right movement as viewed in FIGS. 5A and 5B, and therefore translates the arcuate movement at its upper end to a vertical movement at its lower end where the arm connects to the latch 12. The appropriate vertical movement causes the latch to be switched between a locked and unlocked state.

Thus, it should be appreciated that the latch according to the present invention substantially simplifies the installation thereof into a vehicle door, whilst causing the connection process between the key barrel and key lever to be a simple matter of actuating the outside release handle of the door in which the latch is being installed.

It should further be appreciated that numerous changes may be made within the scope of the present invention. For example, the latch need not be offered up to the door as part of a door module, a similar principle may be employed in releasably restraining other levers or connectors between a door latch and input on the vehicle door. Suitable alternative formations may be employed for the interconnections between the key barrel and key lever and between the outside door release linkage and outside release lever.

1. A door latch for a vehicle door comprising a first lever for the transmission of a first input to the latch from first input means and a second lever for the transmission of a second input to the latch from second input means, wherein the first lever is capable of retaining the second lever in a retracted position when the first lever is in a rest position, but when the first lever is in an actuated position, enables the second lever to move to a deployed position at which the second lever may transmit the second input from the second input means.

2. A door latch according to claim 1 wherein the first lever is an outside release lever and the first input means is an outside release handle.

3. A door latch according to claim 1 or claim 2 wherein the second lever is a key lever and the second input means is a key barrel.

4. A latch according to claim 2 or claim 3 wherein a catch is provided on the outside release lever to releasably retain the key lever.

5. A latch according to any one of claims 2 or claim 4 wherein the release lever pivots about a fixed axis on the latch to move between its rest and release positions.

6. A latch according to any preceding claim wherein a ramp surface is provided on one of the first lever and first input means to be acted on by a link from the other of the first lever and first input means.

7. A latch according to any preceding claim wherein the second lever is resiliently biased towards its deployed position.

8. A latch according to any preceding claim wherein guide means is provided to guide the second lever to its deployed position.

9. A latch according to any preceding claim wherein a formation is provided on the second lever for engagement with the second input means.

10. A latch according to claim 9 wherein the formation comprises at least one projection.

11. A latch according to any preceding claim wherein the second lever is arranged so as to translate a substantially arcuate input motion of the second input means into substantially vertical motion of the second lever.

12. A door module incorporating a latch according to any preceding claim.

13. A door incorporating a latch according to any one of claims 1 to 11.

14. A door according to claim 13 further comprising a key barrel and an outside release handle.

15. A vehicle incorporating a latch according to any one of claims 1 to 11.

16. A method of installing a latch in a vehicle door, the latch having a first lever for the transmission of a first input to the latch from first input means and a second lever for the transmission of a second input to the latch from second input means, the first lever being capable of retaining the second lever in a retracted position when the first lever is in a rest position, the method comprising the steps of:
i) placing the second lever in a retained position using the first lever;
ii) securing the latch relative to the first and second input means;
iii) actuating the first input means so as to release the second input lever such that the second input lever is brought into a deployed position at which it may transmit inputs from the second input means to the latch.

17. A method according to claim 16 wherein the first lever is an outside release lever and the first input means is an outside release handle.

18. A method according to claim 16 or claim 17 wherein the second lever is a key lever and the second input means is a key barrel.
